(19) United States
(12) Patent Application Publication
(10) Pub. No.: US 2024/0193657 A1
(43) Pub. Date: Jun. 13, 2024

(54) GENERATING AN ORDER INCLUDING MULTIPLE ITEMS FROM A USER INTENT DETERMINED FROM UNSTRUCTURED DATA RECEIVED VIA A CHAT INTERFACE

(71) Applicant: Maplebear Inc. (dba Instacart), San Francisco, CA (US)

(72) Inventors: Sneha Chandrababu, Sammamish, WA (US); Karuna Ahuja, San Francisco, CA (US)

(21) Appl. No.: 18/079,544

(22) Filed: Dec. 12, 2022

(51) Int. Cl. G06Q 30/0601

(52) U.S. Cl. CPC G06Q 30/0617; G06Q 30/0633

(57) ABSTRACT

An online concierge system generates an order including multiple items based on unstructured data received from a user through a chat interface instead of manually adding items to the order. The user provides unstructured data to the online concierge system through the chat interface, and the online concierge system extracts an intent from the unstructured data using a natural language process. Based on the intent, the online concierge system identifies a group of items associated with the intent and selects a group of items. The online concierge system generates an order for the user that includes the items comprising the selected group of items.

### BACKGROUND

Many online systems, such as online concierge systems, provide items for acquisition by users. Such an online system generates an order for the user that includes one or more items selected by the user. The items included in the order are subsequently delivered or provided to the user. To select items for inclusion in an order, a user provides inputs to the online system, which retrieves and presents items to the user based on the inputs. For example, an online system receives search terms from the user and displays items having characteristics satisfying the search terms to the user, who selects one or more of the displayed items for inclusion in an order.

However, online systems offer an increasingly large number of items, increasing complexity for a user to create an order. For example, an increased number of items offered by an online system increases inputs from a user to identify items for inclusion in an order. Conventionally, a user manually provides search terms or other information to identify individual items and selects individual items matching one or more search terms for an order. This identification and selection of individual items for an order increases an amount of time and a number of interactions with the online system for a user to create the order.

### SUMMARY

In accordance with one or more aspects of the disclosure, an online concierge system provides a chat interface to a user and receives unstructured data from the user through the chat interface. The unstructured data is text data or audio data in various embodiments. A chatbot executing on the online concierge system receives the unstructured data via the chat interface. The chatbot includes one or more natural language processing methods that analyze the unstructured data received through the chat interface to identify keywords in the unstructured data in some embodiments. The one or more natural language processing methods generate replies to unstructured data received from the user that are displayed to the user via the chat interface. The user may reply to a response, with the chatbot determining an additional response based on the reply and previously received unstructured data, so the unstructured data is conversational data from the user in various embodiments.

One or more natural language processes comprising the chatbot determine an intent of the user from the unstructured data received through the chat interface. The intent is one or more keywords that the online concierge system associates with the chatbot. In some embodiments, the intent specifies an objective that the user seeks to achieve through the online concierge system. In various embodiments, the intent 520 is determined as one of a set of intents stored by the online concierge system. The intent may be determined from one or more keywords or phrases extracted from the unstructured data received through the chat interface.

Based on the intent determined from the unstructured data and intents associated with groups of items by the online concierge system, the online concierge system identifies one or more groups of items each associated with the intent. Each group of items includes a plurality of items. In some embodiments, a group of items is a recipe including multiple items with and a quantity associated with each item. In various embodiments, the online concierge system stores associations between intents and groups of items, such as in a graph with connections between intents and groups of items, so the online concierge system identifies one or more groups of items for which the online concierge system stores data associating the one or more groups of items with the determined intent.

From the identified groups of items associated with the determined intent, the online concierge system selects a group of items. In various embodiments, the online concierge system selects the group of items based on customer data stored in association with the user and item data stored in association with items included in different groups of items associated with the determined intent. Further, in some embodiments, the customer data stored in association with the user includes prior orders received by the online concierge system from the user, allowing the online concierge system to leverage prior inclusion of items in orders by the user when selecting a group of items from identified items associated with the determined intent.

The online concierge system generates an order including the items that comprise the selected group of items. When generating the order, the online concierge system includes each of the items included in the selected group of items in the order. If the selected group of items includes quantities associated with items, the online concierge system specifies the corresponding quantities associated with items in the selected order in the generated order. The online concierge system transmits the generated order to a client device for presentation to the user. The user may interact with the generated order to modify one or more items included in the order, to include additional items in the order, to remove items included in the order, to change quantities of items included in the order, or to perform other modifications to the order.

Using unstructured data obtained from user interaction with a chatbot to determine an intent of the user allows the online concierge system to simplify creation of an order by the user. From the determined intent, the online concierge system selects a group of items that are associated with the intent and includes items comprising the selected group in an order. Thus, rather than a user manually identifying individual items to the online concierge system through different inputs, the online concierge system generates an order for the user's review that leverages stored associations between multiple items and the intent determined for the user. This reduces a number of interactions with the online concierge system for the user to generate an order, which decreases a time for the user to create an order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a flowchart of a method of generating an order for a user of an online concierge system from unstructured data received from the user, in accordance with one or more embodiments.

FIG. 4 illustrates an example graph connecting groups of items with intents, in accordance with one or more embodiments.

FIG. 5 illustrates a process flow diagram of a method of generating an order for a user of an online concierge system from unstructured data received from the user, in accordance with one or more embodiments.

### DETAILED DESCRIPTION

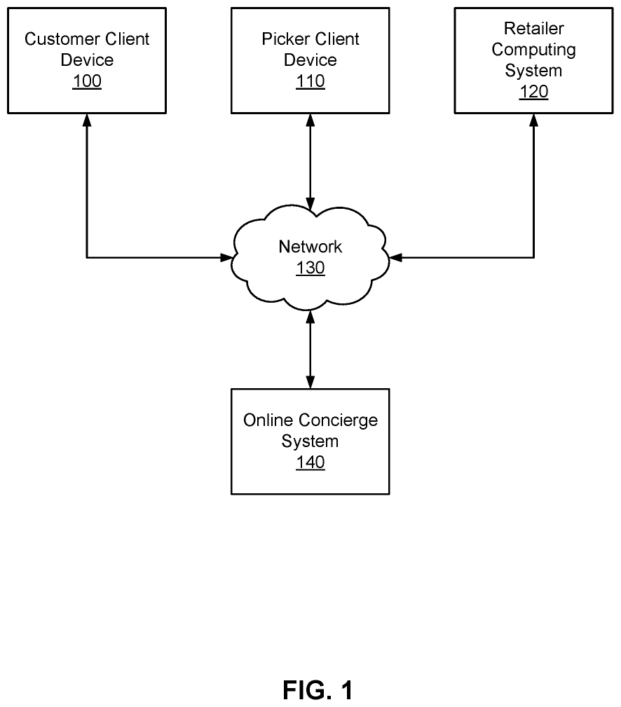

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list. Example updates to a shopping list include changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

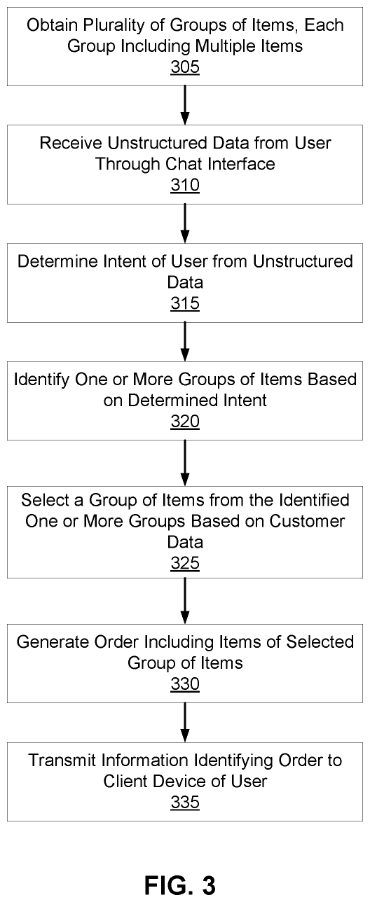

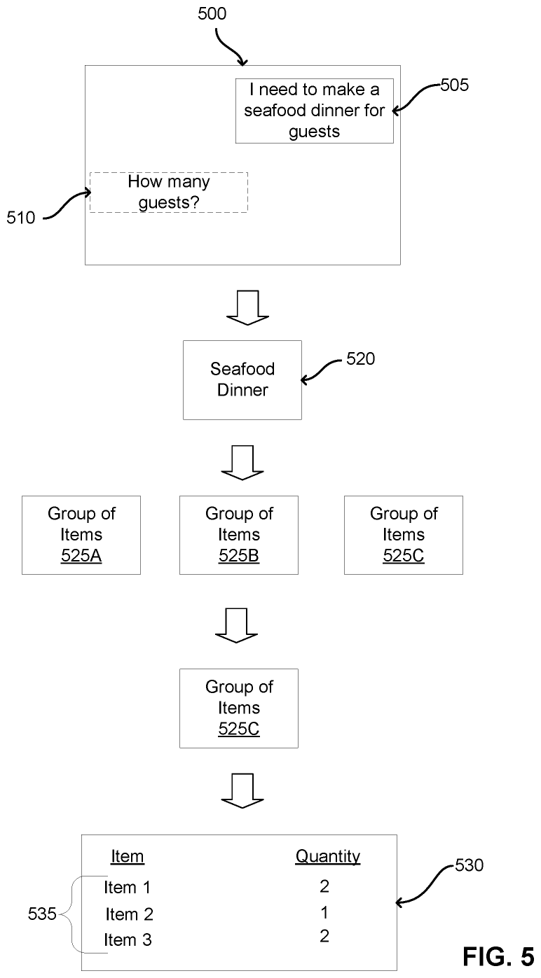

In various embodiments, the customer client device 110 presents a chat interface to a customer. The chat interface receives unstructured data, such as text data or audio data, from a user of the customer client device 100 and transmits the received data to the online concierge system 140. The chat interface also presents data received from the online concierge system 140 to the user. In some embodiments, as further described below in conjunction with FIGS. 3 and 5, data received through the chat interface is received by a chatbot executing on the online concierge system 140, and the chat interface displays data generated by the chatbot that the customer client device 100 receives from the online concierge system 140.

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, a warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

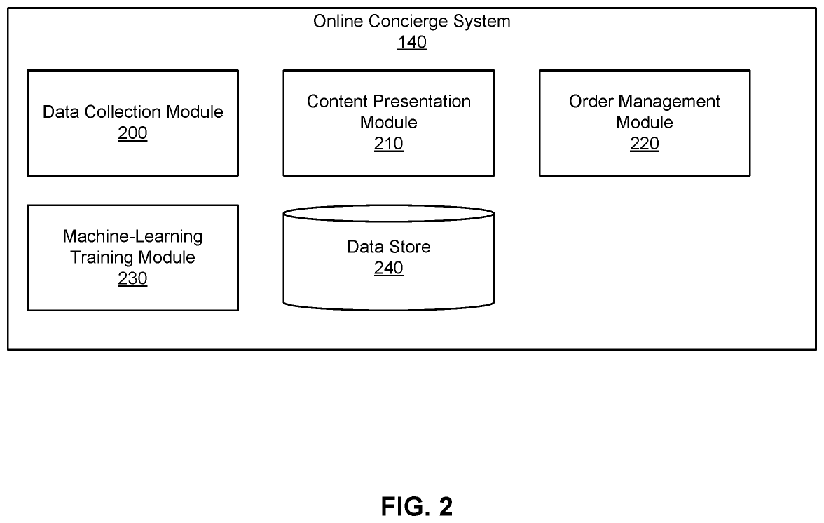

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In various embodiments, the content presentation module 210 includes one or more chatbots. A chatbot comprises one or more natural language processing modules that receive unstructured data, such as text data or audio data, from a user and determines an intent of the user from the unstructured data. In various embodiments, based on the determined intent of the user, a chatbot generates one or more replies that are displayed to the user. For example, a chat interface executing on a customer client device 100 receives unstructured data from a user and transmits the unstructured data to the content presentation module 210. A chatbot included in the content presentation module 210 analyzes the unstructured data and determines an intent of the user. Based on the determined intent, the chatbot may generate one or more replies that are presented to the user through the chat interface, allowing the chatbot to simulate interaction with another user.

Additionally, as further described below in conjunction with FIGS. 3-5, based on the determined intent from unstructured data, the content presentation module 210 generates an order including a plurality of items for the user. The content presentation module 210 identifies one or more groups of items that the online concierge system 140 associates with the determined intent and selects at least one of the identified groups based on user characteristics of the user and item attributes of items included in the identified groups. The content presentation module generates an order for the user that includes each of the items included in the selected group of items and transmits information describing the generated order to a customer device 100, as further described below in conjunction with FIGS. 3 and 5.

The order management module 220 that manages orders for items from customers.

The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

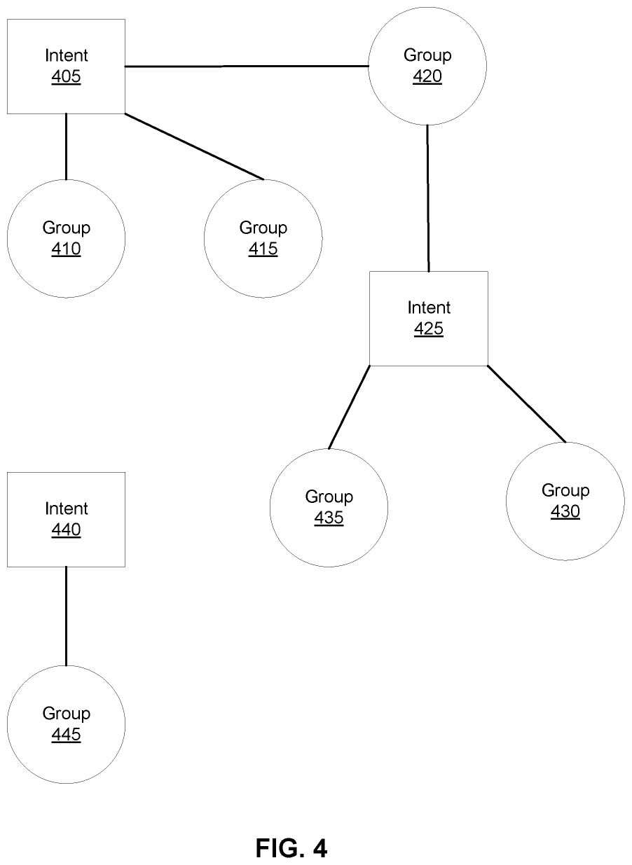

In various embodiments, the data store 240 maintains information describing groups of items and associating one or more intents with different groups of items. An intent comprises a key word or a key phrase that the data store 240 associates with a group of items. In various embodiments, each group of items includes a plurality of items. In some embodiments, a group of items also includes a quantity associated with one or more of the items included in the group of items. For example, a group of items is a recipe including multiple items with a corresponding quantity associated with each item of the recipe. In some embodiments, the data store 240 maintains a graph that identifies connections between intents and groups of items. As further described below in conjunction with FIG. 4, the graph includes nodes representing intents and nodes representing groups of items. A connection between a node representing an intent and a node representing a group of items indicates that the intent is associated with the group of items. As further described below in conjunction with FIGS. 3-5, the online concierge system 140 may use the graph to select one or more groups of items for a user based on unstructured data that the online concierge system 140 received from a user.

FIG. 3 is a flowchart of one or more embodiments of a method of generating an order for a user of an online concierge system from unstructured data received from the user. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

The online concierge system 140 obtains 305 a plurality of groups of items. In some embodiments, the online concierge system 140 retrieves the groups of items from a data store 240 maintained by the online concierge system 140. For example, the data store 240 includes a group identifier for a group of items, with item identifiers associated with the group identifier. The item identifiers associated with a group identifier specify items included in a group corresponding to the group identifier. In some embodiments, a group identifier is associated with one or more item categories, where an item category comprises a set of items that are a similar type of item, as further described above in conjunction with FIG. 2. A group of items may include a combination of items and item categories, allowing a group of items to include specific items and one or more item categories. In other embodiments, the online concierge system 140 retrieves one or more groups of items from a third party system that is external to the online concierge system 140.

In some embodiments, a group of items is a recipe including multiple items and quantities for each item. A recipe includes instructions for combining the items included in the recipe in various embodiments. One or more categories or keywords may be included in or associated with a recipe in various embodiments. Additionally, a recipe includes a quantity associated with each item included in the recipe. However, a group of items may be other types of combinations of multiple items in different embodiments.

Each group of items is associated with one or more intents. As used herein, an “intent” identifies a category or a classification for a group of items. In various embodiments, an intent associated with a group of items is one or more keywords or key phrases that are associated with a group of items. A group of items may be associated with multiple intents. In some embodiments, the online concierge system 140 maintains a graph to identify associations between intents. FIG. 4 shows an example of a graph 400 connecting groups of items with intents. The graph 400 includes nodes each corresponding to groups of items, also referred to as “group nodes,” and nodes corresponding to intents, also referred to as “intent nodes.” The graph 400 includes connections between various pairs of nodes. A connection between a node corresponding to a group of items (a “group node”) and a node corresponding to an intent (an “intent node”) indicates that the intent is associated with the group of items. In various embodiments, the online concierge system 140 stores the graph 400 in the data store 240.

In the example shown by FIG. 4, the example graph 400 includes intent node 405, intent node 425, and intent node 440. In the example of FIG. 4, intent node 405 has connections to group node 410, group node 415, and group node 420. Thus, each of group node 410, group node 415, and group node 420 are associated with an intent corresponding to intent node 405. For example, intent node 405 corresponds to a keyword of “Thanksgiving,” so group node 415, group node 420, and group node 420 are each determined by the online concierge system 140 to be relevant to “Thanksgiving.” In some embodiments, the online concierge system 140 receives inputs from users that associate an intent with a group of items. For example, the online concierge system 140 establishes a connection between intent node 405 and group node 410 in response to receiving input from a threshold amount of users or in response to receiving input from a set of a specific users associating items comprising group node 410 with the intent corresponding to intent node 405. In other embodiments, the online concierge system 140 associates group node 410 with the intent corresponding to intent node 405 based on metadata or content associated with the items comprising group node 410 or based on prior user actions performed with the items comprising group node 410 (e.g., content accessed by the user before or after accessing group of items 525, inclusion of one or more items of group of items 525 in an order, etc.). In other embodiments, the online concierge system 140 applies one or more classification or clustering models to groups of items to associate stored groups of items with an intent.

As shown in FIG. 4, a group of items may be associated with multiple intents. In the example of FIG. 4, group node 420 has a connection to both intent node 405 and intent node 425. Hence, items comprising group node 420 are associated with both an intent corresponding to intent node 405 and an additional intent corresponding to intent node 425. Additionally, intent node 425 has a connection to group node 430 and a connection to group node 435. While FIG. 4 shows an example where group node 420 has a connection to intent node 425 and a connection to intent node 405, in other embodiments, a group of items has connections to any number of intent nodes.

FIG. 4 also shows intent node 440 having a connection to group node 445, with group node 445 and intent node 440 not connected to another intent node. Hence, the graph 400 is not a fully connected graph in various embodiments. The online concierge system 140 updates the graph 400 based on inputs received from users or from interactions by users with groups of items. For example, the online concierge system 140 updates the graph 400 to include a connection between intent node 440 and group node 415 in response to receiving inputs from users or interactions by users that associate items comprising group node 415 with an intent corresponding to intent node 440. This allows the graph 400 to be dynamically modified to account for changes in associations between intents and groups of items by users of the online concierge system 140. In some embodiments, the online concierge system 140 periodically updates the graph 400, while in other embodiments the online concierge system 140 updates the graph 400 as user interactions with items are received.

Referring back to FIG. 3, the online concierge system 140 receives 310 unstructured data from a user through a chat interface. The chat interface is provided by the online concierge system 140. For example, an application associated with the online concierge system 140 executing on a customer client device 100 generates and presents the chat interface to the user. In various embodiments, the online concierge system 140 receives a selection of a retailer from the user and subsequently presents the chat interface to the user. In other embodiments, the online concierge system 140 receives a request to create an order from the user and presents the chat interface to the user in response to the received request. In some embodiments, the online concierge system 140 receives information identifying a retailer (e.g., a retailer name, a retailer identifier) from the user via the chat interface after receiving the request from the user to create the order.

The chat interface receives unstructured data from the user via a customer client device 100, with the unstructured data transmitted from the customer client device 110 to the online concierge system 140 through a network 130. In some embodiments, the customer client device 100 uses an application programming interface (API) to communicate unstructured data received from the user with the online concierge system 140. The unstructured data may be text data that the user enters into the chat interface or may be audio data that the customer client device 100 captures from the user, with the chat interface executing one or more audio transcription methods to convert the audio data into text data (such conversion may be performed by the customer client device 100 or by the online concierge system 140 after receiving the audio data).

In various embodiments, the unstructured data that the online concierge system 140 receives 310 via the chat interface is input to a chatbot executed by the online concierge system 140. As further described above, the chatbot comprises instructions that, when executed by the online concierge system 140, generates replies comprising output text or audio data in response to the received unstructured data. This allows the replies generated by the chatbot to simulate interaction with another user. The chatbot includes one or more natural language processing methods that analyze the unstructured data received through the chat interface to identify keywords in the unstructured data in some embodiments. In other embodiments, the one or more natural language processes analyze content and context of unstructured data received 310 from the user as well as unstructured data the chatbot previously output to the user via the chat interface.

In various embodiments, using the one or more natural language processing methods, the chatbot generates replies to unstructured data received from the user that are displayed to the user via the chat interface. Additional unstructured data is received via the chat interface from the user in response to a reply generated by the chatbot, allowing the online concierge system 140 to continue an exchange of data with the user through the chat interface. Hence, the unstructured data received from the user is conversational data between the user and the chatbot in various embodiments. Replies generated by the chatbot and displayed to the user may be configured to elicit additional information from the user, allowing the online concierge system 140 to increase an amount of information obtained from the user through the chat interface by prompting the user to provide specific information. For example, one or more replies generated by the chatbot request additional details from the user about unstructured data previously received via the chatbot. This allows the chatbot to guide the user to providing more specific or other information that the one or more natural language processes comprising the chatbot further analyzes.

The online concierge system 140 determines 315 an intent of the user from the received unstructured data. A natural language process may comprise one or more neural networks or other machine learning models trained on a corpus of training data to identify keywords in the unstructured data or to identify keywords associated with the unstructured data. In various embodiments, the intent comprises a keyword or a combination of keywords that the online concierge system 140 associates with unstructured data received 310 through the chat interface. In some embodiments, the natural language process is a machine learning model based on a set of training examples. Each training example includes input unstructured data to which the natural language process is applied to generate an output. For example, each training example may include a combination of unstructured data, such as natural language text data. In some cases, the training examples also include a label; a label applied to a training example represents an intent corresponding to the unstructured data included in the training example. The natural language process is trained by comparing its output from input data of a training example to the label for the training example. The online concierge system 140 scores the output from the natural language process using a loss function. A loss function is a function that generates a score for the output of the natural language process such that the score is higher when the natural language process performs poorly and lower when the natural language process performs well. In cases where the training example includes a label, the loss function is also based on the label for the training example. In various embodiments, the score is based on a difference between the label applied to the training example and an output of the natural language process when applied to the training example. Example loss functions include the mean square error function, the mean absolute error, hinge loss function, and the cross entropy loss function. The machine learning training module 230 updates a set of parameters for the natural language process based on the score generated by the loss function. In various embodiments, the online concierge system 140 repeatedly backpropagates the score from application of the natural language process to the training example through layers of a network comprising the natural language process. The backpropagation of the one or more error terms is repeated by the online concierge system 140 until the one or more loss functions satisfy one or more criteria.

In some embodiments, the natural language process extracts one or more tokens from the unstructured data and determines 315 the intent of the user from the unstructured data. In various embodiments, the natural language process extracts one or more tokens from the unstructured data and determines 315 the intent of the user from the extracted tokens using a machine learned model trained as further described above. The one or more natural language processes are applied to unstructured data received from the chat interface as additional data is received from the chat interface, allowing determination of the intent of the user to account for additional unstructured data received from the user. The online concierge system 140 maintains a set of intents and determines 315 the intent of the user as an intent from the set, in various embodiments. Different numbers of intents are included in the set, in various embodiments, and different intents in the set have different levels of specificity. The differing levels of specificity allow the online concierge system 140 to determine an intent of the user from unstructured data having varying levels of detail. For example, unstructured data received 310 via the chat interface is “I need weekly dinner items,” and the online concierge system 140 determines 315 an intent of the user as “dinner.” As another example, unstructured data received 310 via the chat interface is “I want to shop for a Valentine's Day dinner,” and the online concierge system 140 determines 315 an intent of the user as “Valentine's Day dinner.” In another example, unstructured data received 310 via the chat interface is “I have guests coming over who want seafood,” and the online concierge system 140 determines 315 an intent of the user as “seafood dinner for a group.”

In various embodiments, the online concierge system 140 generates replies to prompt the user for additional data via the chat interface based on determination of the intent from the unstructured data. For example, if the online concierge system 140 is unable to determine 315 an intent of the user with at least a threshold confidence level from received unstructured data, one or more natural language processes of the chatbot generate replies to prompt the user for additional data relevant to determining 310 the intent of the user. For example, the chatbot generates replies prompting the user for additional details or information relevant to types of items, numbers of items, an occasion causing the user to provide unstructured data, or other information relevant to one or more intents, with the online concierge system 140 including additional details received as responses to replies in the unstructured data from which one or more intents are determined 315. This allows the online concierge system 140 to elicit additional information from the user to improve an accuracy of the intent determined 315 from the unstructured data received from the chat interface.

Additionally, in some embodiments, one or more replies output by the online concierge system 140 via the chat interface prompt the user about one or more items or about one or more attributes of items. For example, a reply identifies a brand or a manufacturer associated with one or more items and asks whether the user has an interest in the brand or manufacturer. A response to the reply from the user may subsequently be used when selecting one or more items for inclusion in an order for the user. For example, if a response indicates interest in the brand or the manufacturer, the online concierge system 140 stores information in association with the user identifying the brand (or the manufacturer) and the user's interest in the brand (or the manufacturer) to identify items associated with the brand (or the manufacturer) to the user. In the preceding example, the brand (or the manufacturer) identified by the reply may be a brand (or a manufacturer) from which the user has not previously purchased items or may be a brand (or a manufacturer) that provides compensation to the online concierge system 140 in exchange for the online concierge system 140 identifying the brand to the user. In other examples, other characteristics of items may be identified to the user via the chat interface, allowing the online concierge system 140 to receive responses from the user indicating an importance of different item attributes to the user. In some embodiments, a reply generated by the chatbot identifies a specific item to the user and a prompt for the user to indicate if the user is interested in the specific item. As further described below, responses received from the user may be used when selecting items by the online concierge system 140.

The online concierge system 140 identifies 320 one or more of the groups of items that are associated with an intent matching the determined intent. For example, when the online concierge system 140 maintains a graph of groups of items and intents, as further described above in conjunction with FIG. 4, the online concierge system 140 identifies an intent node associated with an intent matching the determined intent and identifies 320 groups of items corresponding to group nodes having a connection to the identified indent node. In various embodiments, the online concierge system 140 identifies 320 groups of items corresponding to group nodes directly connected to an intent node having an intent matching the determined intent.

In various embodiments, the online concierge system 140 generates an embedding for the determined intent, with the embedding comprising a multidimensional vector with values corresponding to each dimension. Hence, the embedding for the determined intent represents the intent in a multidimensional space. The online concierge system 140 retrieves or generates embeddings for each group of items obtained 305 by the online concierge system. The embedding for the determined intent and embeddings for each group of items have a common number of dimensions in various embodiments. The online concierge system 140 identifies 320 the groups of items based on the embedding for the determined intent and the embeddings for the groups of items. For example, the online concierge system 140 determines measures of similarity between the embedding for the determined intent and embeddings for various groups of items. Example measures of similarity between embeddings include a dot product or a cosine similarity, while other measures of similarity may be used in various embodiments. The online concierge system 140 identifies 320 the groups of items based on the measures of similarity. For example, the online concierge system 140 identifies groups of items having embeddings with at least a threshold measure of similarity to the embedding for the determined intent. In another example, the online concierge system 140 ranks groups of items based on the measures of similarity between embeddings for the groups of items and the embedding for the determined intent. Groups of items with embeddings having higher measures of similarity to the embedding for the determined intent have higher positions in the ranking in various embodiments, so the online concierge system 140 identifies 320 groups of items having at least a threshold position in the ranking.

From the identified groups of items, the online concierge system 140 selects 325 a group of items for the user. When selecting 325 the group of items, the online concierge system 140 accounts for stored information associated with the user. For example, the online concierge system 140 retrieves customer data stored in association with the user (e.g., from the data store 240) and selects 325 a group of items based at least in part on the customer data associated with the user. For example, retrieved customer data for the user includes one or more shopping preferences or favorite items of the user, and the online concierge system 140 selects 325 a group of items including item attributes matching at least a threshold amount (e.g., a threshold percentage, a threshold number) of shopping preferences or favorite items included in customer data for the user. In some embodiments, customer data stored for the user includes prior purchases of the user, and the online concierge system 140 selects 325 a group of items including a maximum number of items included in at least a threshold amount (e.g., a threshold percentage, a threshold number) of prior orders received from the user. In other embodiments, the online concierge system 140 selects 325 a group of items including items that the user previously included in orders with at least a threshold frequency or with a threshold frequency. Accounting for customer data stored in association with the user allows the online concierge system 140 to select 325 a group of items from the identified group of items that is more likely to be relevant or to be of interest to the user.

In various embodiments, the selected group of items includes one or more item categories. Based on customer characteristics stored in association with the user, the online concierge system 140 selects an item for an item category of the selected group of items. The online concierge system 140 retrieves items associated with the item category by the online concierge system 140. In some embodiments, the online concierge system 140 selects an item associated with the item category based on prior interactions by the user with items. For example, the online concierge system 140 applies an item selection model to items associated with the item category and selects an item for the item category based on the trained purchase model. The item selection model outputs a probability of the user purchasing an item. The trained purchase model accounts for times when the user previously purchased an item, such as a relative time from a previously received order including the item to a time when the item selection model is applied, as well as attributes of the item (e.g., a type of the item, a quantity or an amount of the item that was previously purchased, a brand of the item). The item selection model may include a decay constant that decreases a weighting of purchases of the items over time, so purchases of the item at longer time intervals from the time when the item selection model is applied have lower weights than weights of purchases at the item at shorter time intervals from the time when the trained purchase model is applied. Additionally, the item selection model accounts for a frequency with which the user purchases an item, which increases a likelihood of the user purchasing an item if the user more frequently purchases the item. Other example factors used by the trained purchase model to determine the likelihood of a user purchasing an item include: a time interval between prior orders including the item received from the user, a frequency with which the item is included in prior orders received from the user, times when orders including the item were previously received from the user, preferences of the user, and any other suitable information. The item selection model may be trained using any suitable method or combination of methods, as further described above in conjunction with FIG. 2. In some embodiments, the online concierge system 140 applies the item selection model to each combination of the user and an item associated with the item category and selects an item associated with the item category having a maximum probability of being purchased by the user. This allows the online concierge system 140 to select an item associated with the item category that the user is most likely to purchase based on prior orders by the user.

Additionally, when selecting an item for the item category, the online concierge system 140 accounts for predicted availabilities of items associated with the item category when selecting an item for the item category. In some embodiments, the online concierge system 140 applies a trained item availability model to the items associated with the item category and to a retailer identified by user. The trained item availability model receives a combination of an item, a retailer, and a time for picking the item as input and outputs a probability of the item being available at the retailer at the time. In various embodiments, the user identifies the retailer to the online concierge system 140 in a request to initiate the chat interface or identifies the retailer to the user through unstructured data provided to the online concierge system through the chat interface, as further described above. The trained item availability model is trained using training data based on previous orders, as further described above in conjunction with FIG. 2, with a training example including a combination of an item and a warehouse and a label indicating whether a probability of the item being available at the warehouse was accurate orders (e.g., if the item was predicted to be available at the warehouse and not found by the shopper, or predicted to be unavailable but found by the shopper).

Application of the trained item availability model allows the online concierge system 140 to determine a predicted availability of different items associated with the item category at the identified retailer. When selecting the item for the item category, the online concierge system 140 selects an item having a maximum probability of being available at the retailer. In some embodiments, the online concierge system 140 ranks items associated with the item category based on their likelihoods of being purchased by the user, as further described above, identifies a set of items having at least a threshold position in the ranking, and selects an item of the set having a maximum probability of being available (or having at least a threshold predicted availability). In other embodiments, the online concierge system 140 ranks items associated with the item category based on their probabilities of being available, identifies a set of items having at least a threshold position in the ranking, and selects an item of the set having a maximum likelihood of being purchased by the user. This allows the online concierge system 140 to select an item for an item category included in the selected group of items that has at least a threshold likelihood of being available at the retailer, while accounting for prior user interactions to identify an item that is most likely to be purchased or to be relevant to a user.

In some embodiments, the online concierge system 140 uses replies from the user received via the chat interface when selecting an item for an item category. For example, in response to a reply from the user indicating the user is interested in a brand (or a manufacturer) identified by the chat interface, the online concierge system 140 selects an item associated with the brand (or the manufacturer) for the item category. In other examples, when a reply from the user via the chat interface indicates an interest in an item attribute identified by the chat interface, the online concierge system 140 selects an item having the item attribute for the item category. This allows the online concierge system 140 to prompt the user for information about one or more items and to account for the user's responses to those prompts when selecting one or more items for inclusion in an order based on the determined interest.

The online concierge system 140 generates 330 an order including the items included in the selected group of items for the user and transmits 335 the order to the customer client device 110 of the user for presentation to the user. Each item included in the selected group of items is included in the order generated 330 by the online concierge system 140, allowing the online concierge system 140 to simplify order creation by including multiple items in the generated order based on the intent determined 315 for the user from the unstructured text. The generated order includes a quantity of each item of the selected group of items that is specified by the selected group of items in various embodiments. In examples where the selected group of items is a recipe, the online concierge system 140 determines a quantity of each item of the selected group items from a corresponding quantity of each item specified by the recipe. Rather than the user individually selecting items for inclusion in an order, the online concierge system 140 allows a user to provide unstructured data, such as natural language data, that the online concierge system 140 analyzes to generate an order including items selected by the online concierge system 140 based on the unstructured data and generate 330. This allows the user to accept or select the order generated 330 by the online concierge system 140 to order items based on the intent of the user, reducing a number of inputs and an amount of time for the user to order items.

In various embodiments, the online concierge system 140 transmits 335 instructions for generating a page of content, such as a web page, to the customer client device 100 of the user identifying the generated order. The page of content includes information identifying each of the items of the group of items that was selected 325 for the user. In some embodiments, the page of content also includes information identifying one or more other groups of items identified 320 based on the intent determined 315 from the unstructured data received 310 from the user. For example, the page of content includes a title or other text identifying or describing one or more other groups of items identified 320 from the determined intent that are each displayed along with an interface element that replaces the group of items selected 325 for the order with items from a group of items displayed in conjunction with the interface element. This allows the user to review or to select other groups of items that the online concierge system 140 associated with the intent determined 315 from the unstructured data.

Additionally, through the page of content (or other information) describing the generated order, the user is capable of modifying the generated order. For example, the user provides one or more inputs to the online concierge system 140 through the page of content to add additional items to the order or to remove one or more items from the order. Additionally, the user may modify quantities of one or more items included in the generated order through interactions with the page of content describing the generated order. This allows the user to further personalize the generated order, while leveraging the items that that online concierge system 140 automatically included in the order based on the unstructured data received 310 from the user.

FIG. 5 shows a process flow diagram of one or more embodiments of a method of generating an order for a user of an online concierge system 140 from unstructured data received from the user. As shown in FIG. 5, the online concierge system 140 provides a chat interface 500 to the user and receives unstructured data 505 from the user through the chat interface 500. In some embodiments, the chat interface 500 is provided to the user in response to the online concierge system 140 receiving a request to create an order from the user, while in other embodiments, the chat interface 500 is provided to the user in response to the online concierge system 140 receiving a selection of a retailer from the user.

Unstructured data received from the user through the chat interface 500 is received by a chatbot executed by the online concierge system 140. As further described above in conjunction with FIG. 4, the chatbot includes one or more natural language processing methods that analyze the unstructured data received through the chat interface to identify keywords in the unstructured data in some embodiments. The one or more natural language processing methods generate replies to unstructured data received from the user that are displayed to the user via the chat interface 500. FIG. 5 shows an example where a reply 510 from the chatbot generated in response to unstructured data 505 from the user is displayed to the user through the chat interface 500. Hence, in various embodiments, the unstructured data received via the chat interface 500 is conversational data including data received from the user in response to one or more replies generated by the online concierge system 140 and presented via the chat interface 500.

As further described above in conjunction with FIG. 3, one or more natural language processes comprising the chatbot determine an intent 520 of the user from the unstructured data received through the chat interface 500. In the example of FIG. 5, the one or more natural language processes determine an intent 520 of “seafood dinner” from the unstructured data the online concierge system 140 received through the chat interface 500. In various embodiments, the intent 520 is determined as one of a set of intents stored by the online concierge system 140. The intent may be determined from one or more keywords or phrases extracted from the unstructured data received through the chat interface 500. In various embodiments, unstructured data received from the user and replies generated by the chatbot are input to the one or more natural language processes to determine the intent 520 of the user.

Based on the intent 520 determined from the unstructured data and intents associated with groups of items by the online concierge system 140, the online concierge system 150 identifies group of items 525A, group of items 525B, and group of items 525B, which are each associated with the intent 520. As further described above in conjunction with FIGS. 3 and 4, in various embodiments, the online concierge system 140 stores associations between intents and groups of items, such as in a graph with connections between intents and groups of items, so the online concierge system 140 identifies one or more groups of items for which stored data associates the one or more groups of items with intent 520. Each group of items includes a plurality of items, and in some embodiments, a group of items includes a quantity associated with each of the plurality of items. For example, a group of items is a recipe including a plurality of items and a corresponding quantity associated with each item. However, in other embodiments, a group of items includes other combinations of multiple items.

From the groups of items identified based on the intent 520, the online concierge system 140 selects a group of items, as further described above in conjunction with FIG. 3. In the example of FIG. 5, the online concierge system 140 selects group of items 525C from group of items 525A, group of items 525B, and group of items 525C. In various embodiments, the online concierge system 150 selects group of items 525C based on customer data stored in association with the user and item data stored in association with items included in group of items 525C. Further, in some embodiments, the customer data stored in association with the user includes prior orders received by the online concierge system 140 from the user, allowing the online concierge system 140 to leverage prior inclusion of items in orders by the user when selecting a group of items.

The online concierge system 140 generates an order 530 including the items comprising the selected group of items, group of items 525C in the example of FIG. 5. When generating the order 530, the online concierge system 140 includes each of the items included in the selected group of items in the order 530. In the example of FIG. 5, items 535 that are included in group of items 525C are included in the order 530. When generating the order 530, the online concierge system 140 determines quantities of each item included in the order 530 from information included in the group of items 525C. For example, group of items 525C is a recipe that includes a plurality of items, with a quantity associated with each item. Each item included in the order 530 has a corresponding quantity that was associated with an item by the recipe. As further described above in conjunction with FIG. 5, information describing the generated order 530 is displayed to the user through a customer client device 110. The user may make one or more modifications to the order 530 by interacting with the displayed information, allowing the user to add, remove, or replace items from the order 530 or to modify quantities of items included in the order 530.

As shown in FIG. 5, the online concierge system 140 simplifies order generation for a user by analyzing unstructured data received by the user. For example, the unstructured text data is conversational data obtained from user interaction with a chatbot from which an intent of the user is determined. This allows the user to specify an intent or a goal for a user that the online concierge system 140 leverages to generate an order for the user. The chat interface allows the user to provide unstructured data replicating the user interacting with another user, from which the online concierge system 140 determines an intent for the user. From the intent determined from the unstructured data, the online concierge system 140 selects a group of items that are associated with the intent and generates an order that includes the items comprising the selected group of items. Thus, rather than a user manually identifying individual items to the online concierge system 140 through different inputs, the online concierge system 140 generates an order for the user's review by leveraging stored associations between multiple items and the intent determined for the user. This use of unstructured data from the user through a chat interface reduces a number of interactions with the online concierge system 140 for the user to generate an order through the online concierge system 140.

### Additional Considerations

The foregoing description of the embodiments has been presented for the purpose of illustration, and many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable storage medium:
obtaining a plurality of groups of items at the computer system, each group of items including a plurality of items and associated with one or more intents;
receiving unstructured data including text from a user through a chat interface provided by the computer system;
determining an intent of the user from the unstructured data;
identifying one or more groups of items associated with an intent matching the determined intent;
selecting a group of items from the identified one or more groups of items based on characteristics of the user maintained by the computer system;
generating an order including the plurality of items included in the selected group of items for the user; and
transmitting the order to a client device for presentation to the user, wherein transmitting the order to the client device causes the client device to display the order.

2. The method of claim 1, wherein the unstructured data comprises conversational data including data received from the user in response to one or more replies generated by a chatbot executing on the computer system and presented to the user through the chat interface.

3. The method of claim 1, wherein identifying one or more groups of items associated with the intent matching the determined intent comprises:
retrieving a graph maintained by the computing system including connections between intents and groups of items; and
identifying one or more groups of items connected to the intent in the graph.

4. The method of claim 1, wherein identifying one or more groups of items associated with the intent matching the determined intent comprises:
determining an embedding for the determined intent;
obtaining embeddings for different groups of items; and
identifying the one or more groups of items based on measures of similarity between the embedding for the determined intent and embeddings for groups of items.

5. The method of claim 1, wherein selecting the group of items from the identified one or more groups of items based on characteristics of the user maintained by the computer system comprises:
selecting a group of items from the identified one or more groups of items that includes items with item attributes matching at least a threshold amount of shopping preferences stored in association with the user.

6. The method of claim 1, wherein selecting the group of items from the identified one or more groups of items based on characteristics of the user maintained by the computer system comprises:
selecting a group of items from the identified one or more groups of items that includes items matching at least a threshold amount of favorite items stored in association with the user.

7. The method of claim 1, wherein selecting the group of items from the identified one or more groups of items based on characteristics of the user maintained by the computer system comprises:
selecting a group of items from the identified one or more groups of items including a maximum number of items included in at least a threshold amount of includes items matching at least a threshold amount of prior orders received from the user.

8. The method of claim 1, wherein generating the order including the plurality of items included in the selected group of items for the user comprises:
identifying an item category included in the selected group of items;
selecting an item associated with the item category based on prior interactions by the user with items; and
generating the order including the selected item associated with the item category and other items included in the selected group of items.

9. The method of claim 1, wherein the selected group of items comprises a recipe including a plurality of items and quantities associated with each of the plurality of items.

10. The method of claim 9, wherein generating the order including the plurality of items included in the selected group of items for the user comprises:
including each item included in the recipe with a corresponding quantity associated with an item by the recipe in the order.

11. A computer program product comprising a non-transitory computer readable storage medium having instructions encoded thereon that, when executed by a processor, cause the processor to:
obtain a plurality of groups of items at a computer system, each group of items including a plurality of items and associated with one or more intents;
receive unstructured data including text from a user through a chat interface provided by the computer system;
determine an intent of the user from the unstructured data;
identify one or more groups of items associated with an intent matching the determined intent;
select a group of items from the identified one or more groups of items based on characteristics of the user maintained by the computer system;
generate an order including the plurality of items included in the selected group of items for the user; and
transmit the order to a client device for presentation to the user, wherein transmitting the order to the client device causes the client device to display the order.

12. The computer program product of claim 11, wherein the unstructured data comprises conversational data including data received from the user in response to one or more replies generated by a chatbot executing on the computer system and displayed to the user.

13. The computer program product of claim 11, wherein identify one or more groups of items associated with the intent matching the determined intent comprises:
determine an embedding for the determined intent;
obtain embeddings for different groups of items; and
identify the one or more groups of items based on measures of similarity between the embedding for the determined intent and embeddings for groups of items.

14. The computer program product of claim 11, wherein select the group of items from the identified one or more groups of items based on characteristics of the user maintained by the computer system comprises:
select a group of items from the identified one or more groups of items that includes items with item attributes matching at least a threshold amount of shopping preferences stored in association with the user.

15. The computer program product of claim 11, wherein select the group of items from the identified one or more groups of items based on characteristics of the user maintained by the computer system comprises:
select a group of items from the identified one or more groups of items that includes items matching at least a threshold amount of favorite items stored in association with the user.

16. The computer program product of claim 11, wherein select the group of items from the identified one or more groups of items based on characteristics of the user maintained by the computer system comprises:
select a group of items from the identified one or more groups of items including a maximum number of items included in at least a threshold amount of includes items matching at least a threshold amount of prior orders received from the user.

17. The computer program product of claim 11, wherein generate the order including the plurality of items included in the selected group of items for the user comprises:
identify an item category included in the selected group of items;
select an item associated with the item category based on prior interactions by the user with items; and
generate the order including the selected item associated with the item category and other items included in the selected group of items.

18. The computer program product of claim 11, wherein the selected group of items comprises a recipe including a plurality of items and quantities associated with each of the plurality of items.

19. The computer program product of claim 18, wherein generate the order including the plurality of items included in the selected group of items for the user comprises:
include each item included in the recipe with a corresponding quantity associated with an item by the recipe in the order.

20. A system comprising:
a processor; and
a non-transitory computer readable storage medium having instructions encoded thereon that, when executed by the processor, cause the processor to:
obtain a plurality of groups of items at the computer system, each group of items including a plurality of items and associated with one or more intents;
receive unstructured data including text from a user through a chat interface provided by the computer system;
determine an intent of the user from the unstructured data;
identify one or more groups of items associated with an intent matching the determined intent;
select a group of items from the identified one or more groups of items based on characteristics of the user maintained by the computer system;
generate an order including the plurality of items included in the selected group of items for the user; and
transmit the order to a client device for presentation to the user, wherein transmitting the order to the client device causes the client device to display the order.
